(19) United States
(12) Patent Application Publication
(10) Pub. No.: US 2026/0287428 A1
(43) Pub. Date: Sep. 24, 2026

(54) COLOR MEASUREMENT DEVICE AND IMAGE FORMING APPARATUS

(71) Applicant: KONICA MINOLTA, INC., Tokyo (JP)

(72) Inventors: Harumitsu FUJIMORI, Tokyo (JP); Yoshito HASHIMURA, Kawasaki-shi (JP)

(21) Appl. No.: 19/564,318

(22) Filed: Mar. 12, 2026

(30) Foreign Application Priority Data
Mar. 18, 2025 (JP) 2025-043094

(51) Int. Cl. G01J 3/50

(52) U.S. Cl. CPC G01J 3/50

(57) ABSTRACT

A color measurement device includes: first detection means that detects an inclination of a recording medium on which a colorimetric patch is formed and which is conveyed in a first direction; a first hardware processor that controls conveyance of the recording medium based on the inclination of the recording medium detected by the first detection means; and a color measurement sensor that is able to measure a color of the colorimetric patch on the recording medium that is conveyed, being controlled by the first hardware processor.

### CROSS-REFERENCE TO RELATED APPLICATION

The entire disclosure of Japanese patent application No. 2025-043094, filed on Mar. 18, 2025, is incorporated herein by reference in its entirety.

### BACKGROUND OF THE INVENTION

### 1. Technical Field

The present invention relates to a color measurement device and an image forming apparatus.

### 2. Description of Related Art

A color measurement device that measures colors of multiple colorimetric patches formed on a recording medium such as a sheet is known (see, for example, Japanese Unexamined Patent Application Publication No. 2023-034825). The multiple colorimetric patches vary in color, density, and the like. The color measurement device includes, for example, a color measurement sensor. The color measurement sensor detects the colorimetric patches, by which the color characteristics and the like of an image forming apparatus can be calibrated.

### SUMMARY OF THE INVENTION

When the color measurement device described above performs color measurement in a state where the recording medium is inclined, the color characteristics and the like may not be able to be accurately calibrated. In view of this, it is desirable that the color measurement of the colorimetric patch is adjusted according to the inclination of the recording medium.

The present invention has been made in view of the above-mentioned circumstances. An object of the present invention is to provide a color measurement device and an image forming apparatus capable of adjusting color measurement for a colorimetric patch according to inclination of a recording medium.

To achieve at least one of the abovementioned objects, according to an aspect of the present invention, a device reflecting one aspect of the present inventions comprises the followings.

A color measurement device including: first detection means that detects an inclination of a recording medium on which a colorimetric patch is formed and which is conveyed in a first direction; a first hardware processor that controls conveyance of the recording medium based on the inclination of the recording medium detected by the first detection means; and a color measurement sensor that is able to measure a color of the colorimetric patch on the recording medium that is conveyed, being controlled by the first hardware processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic configuration diagram illustrating an example of an image forming apparatus according to an embodiment;

FIG. 2 is a block diagram illustrating an example of a functional configuration of the image forming apparatus illustrated in FIG. 1;

FIG. 3 is a diagram illustrating an example of a colorimetric patch printed material formed by an image former illustrated in FIG. 1;

FIG. 4 is a diagram illustrating an example of a color measurement device illustrated in FIG. 1;

FIG. 5 is a diagram illustrating an example of a relationship between a front end detection sensor illustrated in FIG. 4 and the colorimetric patch printed material;

FIG. 6 is a diagram for describing the inclination detected by the front end detection sensor illustrated in FIG. 4;

FIG. 7 is a flowchart illustrating an example of color measurement processing performed by a controller illustrated in FIG. 1;

FIG. 8 is a subroutine flowchart illustrating an example of a process of step S107 illustrated in FIG. 7;

FIG. 9A is a diagram illustrating an example of a position where a color measurement head illustrated in FIG. 4 is located;

FIG. 9B is a diagram illustrating another example of a position where the color measurement head illustrated in FIG. 4 is located;

FIG. 9C is a diagram illustrating still another example of a position where the color measurement head illustrated in FIG. 4 is located;

FIG. 10A is a diagram illustrating an example of a relationship between the color measurement head and colorimetric patches illustrated in FIG. 4;

FIG. 10B is a diagram illustrating another example of the relationship between the color measurement head and the colorimetric patches illustrated in FIG. 4;

FIG. 10C is a diagram illustrating still another example of the relationship between the color measurement head and the colorimetric patches illustrated in FIG. 4;

FIG. 10D is a diagram illustrating still another example of the relationship between the color measurement head and the colorimetric patches illustrated in FIG. 4;

FIG. 10E is a diagram illustrating still another example of the relationship between the color measurement head and the colorimetric patches illustrated in FIG. 4;

FIG. 11 is a flowchart illustrating an example of color measurement processing performed by an image forming apparatus according to a first modification example;

FIG. 12 is a diagram illustrating a process of step S724 illustrated in FIG. 11; and

FIG. 13 is a flowchart illustrating an example of color measurement processing performed by an image forming apparatus according to a second modification example.

### DETAILED DESCRIPTION

Hereinafter, one or more embodiments of the present invention will be described with reference to the drawings. However, the scope of the invention is not limited to the disclosed embodiments.

### Embodiment

### [Configuration of Image Forming Apparatus]

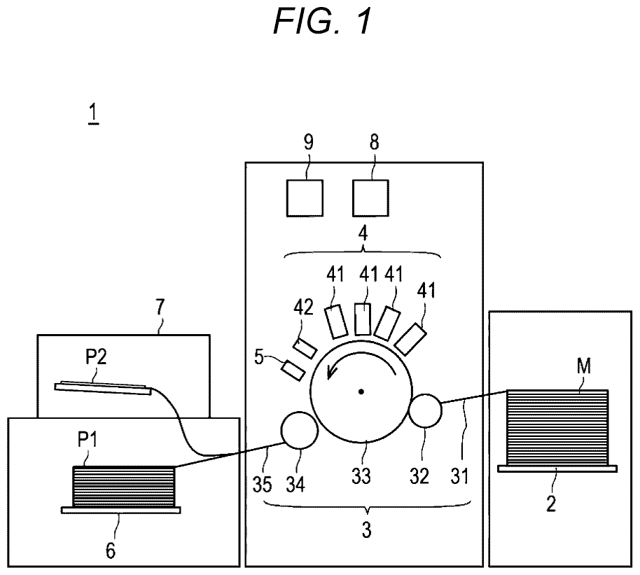

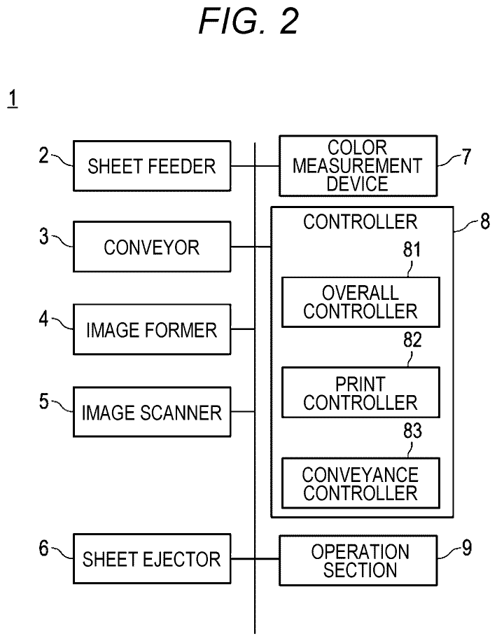

FIG. 1 illustrates a schematic configuration of an image forming apparatus 1 according to an embodiment, and FIG. 2 illustrates an example of a functional configuration of the image forming apparatus 1. The image forming apparatus 1 forms an image on a recording medium M with, for example, an inkjet method. The image forming apparatus 1 includes, for example, a sheet feeder 2, a conveyor 3, an image former 4, an image scanner 5, a sheet ejector 6, a color measurement device 7, a controller 8 (i.e., a first hardware processor), and an operation section 9. The image forming apparatus 1 may employ, as an image forming method, a method other than the inkjet method such as an electrophotographic method.

The sheet feeder 2 stores, for example, a plurality of recording media M. The sheet feeder 2 includes, for example, a tray, and a plurality of recording media Mis stacked and stored on the tray. The recording medium M is, for example, sheet, textile, sheet-like resin, or the like. The sheet is plain paper, coated paper, or the like.

The conveyor 3 includes, for example, a feeder board 31, a first delivery drum 32, a conveyance drum 33, a second delivery drum 34, and a discharge section 35.

The feeder board 31 conveys the recording medium M from the sheet feeder 2 to the first delivery drum 32. The first delivery drum 32 picks up the recording medium M conveyed by the feeder board 31 by holding one end thereof, and delivers the recording medium M to the conveyance drum 33.

The conveyance drum 33 has, for example, a columnar shape. For example, the recording medium M is conveyed while being attracted to and held on a side surface of the cylindrical conveyance drum 33. The conveyance drum 33 rotates in one direction with its central axis serving as a rotation axis while holding the recording medium M on its side surface. Thus, the recording medium M held by the conveyance drum 33 is conveyed. Images are formed on the recording media M held on the conveyance drum 33 by the image former 4, to form a normal printed material P1 and a colorimetric patch printed material P2.

The second delivery drum 34 picks up the normal printed material P1 and the colorimetric patch printed material P2 held on the conveyance drum 33 by holding one ends thereof and delivers them to the discharge section 35.

The discharge section 35 constitutes a discharge route of the normal printed material P1 and the colorimetric patch printed material P2. The discharge section 35 includes, for example, a belt and a roller. The discharge section 35 conveys the normal printed material P1 to the sheet ejector 6 and conveys the colorimetric patch printed material P2 to the color measurement device 7. The discharge route constituted by the discharge section 35 may be branched between the second delivery drum 34 and both the sheet ejector 6 and the color measurement device 7. The sheet ejector 6 to which the normal printed material P1 is ejected includes, for example, a tray. For example, a plurality of normal printed materials P1 is stacked on the tray.

The image former 4 forms the normal printed material P1 and the colorimetric patch printed material P2 with an inkjet method. The image former 4 includes, for example, at least one head unit 41 and an ultraviolet irradiator 42.

The head unit 41 is disposed, for example, at a position facing a side surface of the conveyance drum 33. The head unit 41 includes one or a plurality of inkjet heads. The head unit 41 ejects ink onto the recording medium M held on the conveyance drum 33 at an appropriate timing in accordance with the rotation of the conveyance drum 33. Thus, an image is formed on the recording medium M. The image former 4 forms the normal printed material P1 and the colorimetric patch printed material P2 with, for example, a single pulse method. The image former 4 includes, for example, four head units 41. The four head units 41 correspond to inks of four colors, for example, yellow, magenta, cyan, and black, respectively. As the ink, an ultraviolet curable ink, for example, can be used. Another type of ink may be used as the ink for the image former 4.

The ultraviolet irradiator 42 irradiates, for example, the ink ejected onto the recording medium M with ultraviolet rays. Thus, the ink on the recording medium M is cured.

Jobs executed by the image former 4 include, for example, a normal job for forming the normal printed material P1 and a color measurement job for forming the colorimetric patch printed material P2. The normal printed material P1 is a printed material that is not a subject for color measurement, and is conveyed from the image former 4 to the sheet ejector 6. Multiple colorimetric patches are formed on the colorimetric patch printed material P2. The colorimetric patch printed material P2 is conveyed from the image former 4 to the color measurement device 7 and is subjected to color measurement. Here, the color measurement includes measurement of color information of each colorimetric patch. The color information includes, for example, information about color values such as L*a*b* values. The normal printed material P1 and the colorimetric patch printed material P2 may include the same image.

The image scanner 5 includes, for example, a light source and a light receiver. The light source irradiates the normal printed material P1 and the colorimetric patch printed material P2 with light. The light receiver receives light reflected from the normal printed material P1 and the colorimetric patch printed material P2. On the basis of the reflection light, information indicating the occurrence of a defect in the normal printed material P1 and the colorimetric patch printed material P2, the position of deficiency of a nozzle, and the like is generated. In the image scanner 5, for example, a plurality of light receivers is arranged along a direction orthogonal to the conveyance direction of the recording medium M. The image scanner 5 forms, for example, an inline sensor. The information acquired by the image scanner 5 is transmitted to, for example, the controller 8.

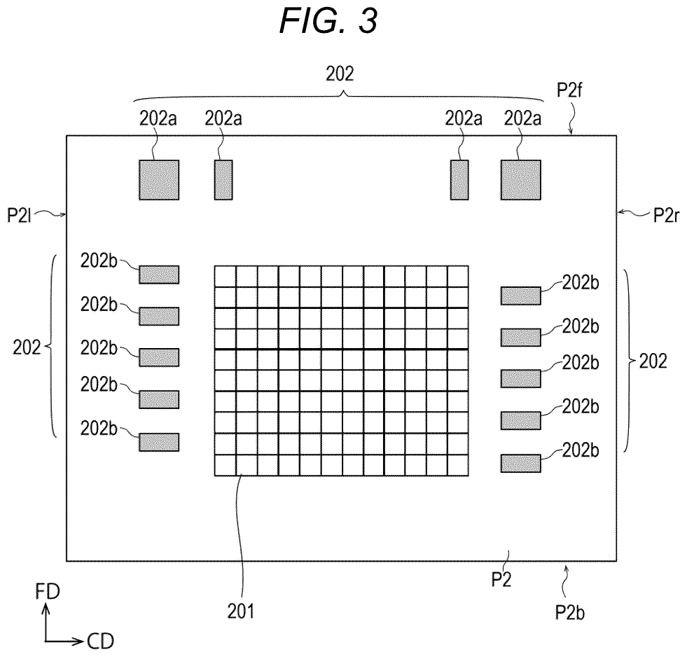

FIG. 3 illustrates an example of the configuration of the colorimetric patch printed material P2 formed by the image former 4. The colorimetric patch printed material corresponds to a specific example of the recording medium in the present invention. The size of the colorimetric patch printed material P2 is, for example, B2 size (515 mm×728 mm). On the colorimetric patch printed material P2, for example, multiple colorimetric patches 201 and multiple position patches 202 are printed. In the following description, the conveyance direction of the colorimetric patch printed material P2 may be referred to as feed direction (FD direction), and the direction parallel to the plane of the colorimetric patch printed material P2 and intersecting the FD direction may be referred to as cross direction (CD direction). The CD direction is, for example, orthogonal to the FD direction. Here, the FD direction corresponds to a specific example of a first direction in the present invention, and the CD direction corresponds to a specific example of a second direction in the present invention.

The colorimetric patch printed material P2 has a front end P2f and a back end P2b facing each other in the FD direction, and a left end P21 and a right end P2r facing each other in the CD direction. The front end P2f and the back end P2b are end portions of the colorimetric patch printed material P2 in the FD direction. When the colorimetric patch printed material P2 is conveyed in the color measurement device 7, the front end P2f is located on the downstream side in the FD direction relative to the back end P2b. The left end P21 and the right end P2r are end portions of the colorimetric patch printed material P2 in the CD direction.

The multiple colorimetric patches 201 are arranged, for example, in the middle of the colorimetric patch printed material P2 in each of the FD direction and the CD direction. The multiple colorimetric patches 201 are arranged, for example, in a matrix in the CD direction and the FD direction. The colorimetric patches 201 in, for example, 10 rows and 12 columns are formed on the colorimetric patch printed material P2. In the following description, the row on the front end P2f side may be referred to as a first row, and the column on the left end P21 side may be referred to as a first column. The colorimetric patches 201 are different from each other in, for example, color tone and density. The colorimetric patches 201 have, for example, the same shape. Each of the colorimetric patches 201 has, for example, a quadrangular shape.

The position patches 202 include, for example, multiple CD-position patches 202a and multiple FD-position patches 202b. When the recording medium M is white, the position patches 202 are printed in black, for example. This makes it easier for the color measurement device 7 to detect the position patches 202. Each of the position patches 202 has, for example, a rectangular shape.

The multiple CD-position patches 202a are, for example, arranged at positions closer to the front end P2f with respect to the multiple colorimetric patches 201. The multiple CD-position patches 202a are, for example, spaced apart from each other in the CD direction. The color measurement device 7 detects the multiple CD-position patches 202a to recognize the position of the colorimetric patch printed material P2 in the CD direction.

For example, four CD-position patches 202a are arranged on the colorimetric patch printed material P2. Two CD-position patches 202a are arranged at positions overlapping the colorimetric patches 201 in the CD direction, and the remaining CD-position patches 202a are arranged at positions closer to the left end P21 and the right end P2r, respectively, with respect to the colorimetric patches 201 in the CD direction. For example, the two CD-position patches 202a arranged at positions overlapping the colorimetric patches 201 are arranged at positions corresponding to the colorimetric patches 201 in the columns closest to the left end P21 and the right end P2r in the CD direction, that is, in the first column and the twelfth column.

The multiple FD-position patches 202b are arranged, for example, between the colorimetric patches 201 and the left end P21 and between the colorimetric patches 201 and the right end P2r. The multiple FD-position patches 202b are, for example, spaced apart from each other in the FD direction. The multiple FD-position patches 202b are arranged, for example, at positions corresponding to the colorimetric patches 201 in each row in the FD direction. The color measurement device 7 detects the multiple FD-position patches 202b to recognize the position of the colorimetric patch printed material P2 in the FD direction.

For example, ten FD-position patches 202b are arranged on the colorimetric patch printed material P2. Five FD-position patches 202b are arranged between the colorimetric patches 201 and the left end P21, and the remaining FD-position patches 202b are arranged between the colorimetric patches 201 and the right end P2r. For example, the five FD-position patches 202b arranged between the colorimetric patches 201 and the left end P21 are arranged at positions corresponding to the colorimetric patches 201 in the odd-numbered rows (first row, third row, fifth row . . . ) in the FD direction. For example, the remaining FD-position patches 202b arranged between the colorimetric patches 201 and the right end P2r are arranged at positions corresponding to the colorimetric patches 201 in the even-numbered rows (second row, fourth row, sixth row . . . ) in the FD direction.

For example, the positions of the FD-position patches 202b in the CD direction are aligned with the positions of the CD-position patches 202a closest to the left end P21 and the right end P2r, respectively, in the CD direction.

The color measurement device 7 is, for example, provided in-line in the image forming apparatus 1. The color measurement device 7 measures color information of each of the multiple colorimetric patches 201 formed by the image former 4. Since the image forming apparatus 1 includes the color measurement device 7, it is possible to more simply calibrate the color characteristics and the like of the image formed by the image former 4.

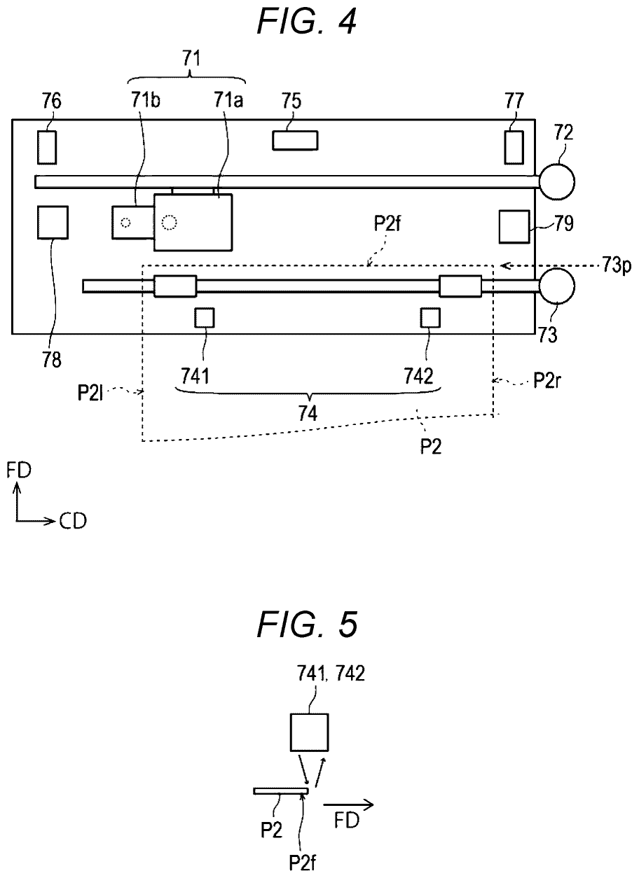

FIG. 4 illustrates an example of a specific configuration of the color measurement device 7. The color measurement device 7 includes, for example, a color measurement head 71, a first motor 72, a second motor 73, a front end detection sensor 74, a back end detection sensor 75, a left home sensor 76, a right home sensor 77, a white calibration plate 78, and a calculator 79 (i.e., a second hardware processor and a third hardware processor).

The color measurement head 71 detects the multiple colorimetric patches 201 and the multiple position patches 202 printed on the colorimetric patch printed material P2. The color measurement head 71 includes, for example, a color measurement sensor 71a and a position sensor 71b. The color measurement sensor 71a detects each of the multiple colorimetric patches 201. For example, the color measurement sensor 71a optically detects the colorimetric patch 201. The color measurement sensor 71a includes, for example, a spectral colorimeter, and spectrally disperses and detects light reflected from each of the colorimetric patches 201.

The position sensor 71b is disposed adjacent to the color measurement sensor 71a in the CD direction, for example. The position sensor 71b and the color measurement sensor 71a are integrally attached, for example. The position sensor 71b detects each of the multiple position patches 202. The position sensor 71b optically detects the position patch 202, for example. The position sensor 71b includes, for example, an optical fiber sensor or a color sensor, and receives reflected light from each of the position patches 202. The optical fiber sensor receives, for example, light having a single wavelength.

The first motor 72 is connected to the color measurement head 71 and drives the color measurement head 71 in the CD direction. The first motor 72 reciprocates the color measurement head 71 in the CD direction. In the color measurement head 71, the color measurement sensor 71a and the position sensor 71b move in the CD direction in a state of being integrated.

The second motor 73 is disposed, for example, upstream from the first motor 72 in the FD direction. The second motor 73 nips the colorimetric patch printed material P2 and conveys the colorimetric patch printed material P2 in the FD direction. The second motor 73 nips the vicinity of the front end P2f of the colorimetric patch printed material P2, thereby allowing the colorimetric patch printed material P2 to wait at a predetermined standby position in the FD direction. At the standby position of the colorimetric patch printed material P2, the front end P2f of the colorimetric patch printed material P2 is located at a position 73p in the FD direction. The position 73p in the FD direction is, for example, a position upstream from the color measurement head 71 and downstream from the front end detection sensor 74 in the FD direction. When the second motor 73 nipping the colorimetric patch printed material P2 is driven, the colorimetric patch printed material P2 is conveyed in the FD direction.

The front end detection sensor 74 is disposed upstream of the color measurement head 71 in the FD direction, and detects the front end P2f of the colorimetric patch printed material P2. The front end detection sensor 74 includes, for example, a first front end detection sensor 741 and a second front end detection sensor 742 which are spaced apart from each other in the CD direction. For example, the first front end detection sensor 741 detects the front end P2f at a position closer to the left end P21, and the second front end detection sensor 742 detects the front end P2f at a position closer to the right end P2r. Although described in detail later, the inclination of the colorimetric patch printed material P2 is detected by the front end detection sensor 74 in the present embodiment. The first front end detection sensor 741 and the second front end detection sensor 742 each include, for example, a light emitter and a light receiver. Here, the first front end detection sensor 741 and the second front end detection sensor 742 correspond to specific examples of a first end sensor and a second end sensor in the present invention.

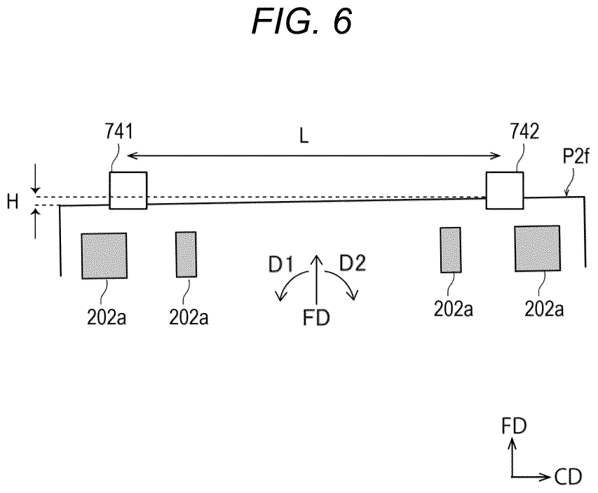

FIG. 5 schematically illustrates an example of a relationship between the first front end detection sensor 741 and the front end P2f of the colorimetric patch printed material P2. The light emitter of the first front end detection sensor 741 emits light to the conveyance path of the colorimetric patch printed material P2. When the front end P2f of the colorimetric patch printed material P2 passes through the conveyance path, the light is reflected by the front end P2f. The light receiver of the first front end detection sensor 741 detects the front end P2f by receiving the light reflected from the front end P2f. For example, the second front end detection sensor 742 also has the same configuration as the first front end detection sensor 741.

The back end detection sensor 75 is disposed downstream from the color measurement head 71 in the FD direction, for example. The back end detection sensor 75 detects, for example, the back end P2b of the colorimetric patch printed material P2.

The left home sensor 76 and the right home sensor 77 are disposed, for example, at positions facing each other in the CD direction. The left home sensor 76 and the right home sensor 77 are disposed downstream from the color measurement head 71 in the FD direction, for example. The left home sensor 76 and the right home sensor 77 are disposed, for example, at both ends of an area in which the color measurement head 71 is movable. The white calibration by the color measurement sensor 71a is performed with the white calibration plate 78.

The calculator 79 calculates an inclination T1 of the colorimetric patch printed material P2 on the basis of the information detected by each of the first front end detection sensor 741 and the second front end detection sensor 742. The calculator 79 calculates, for example, the direction and the degree of the inclination T1 of the colorimetric patch printed material P2. The inclination T1 includes, for example, the direction and the degree of inclination of the front end P2f of the colorimetric patch printed material P2 with respect to the CD direction.

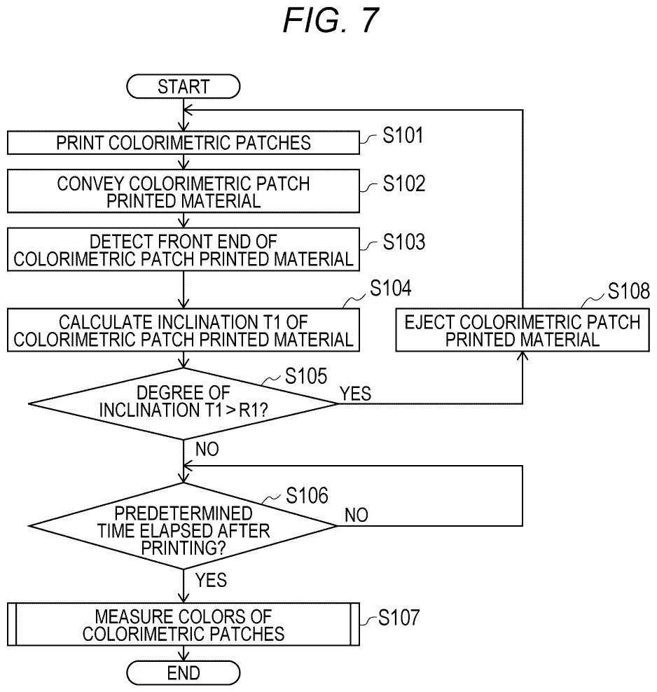

FIG. 6 illustrates an example of the colorimetric patch printed material P2 conveyed in a state where the front end P2f is inclined with respect to the CD direction. In this case, the first front end detection sensor 741 and the second front end detection sensor 742 detect the front end P2f of the colorimetric patch printed material P2 at timings different from each other. The calculator 79 calculates the inclination T1 of the colorimetric patch printed material P2 using the difference between the detection timings of the first front end detection sensor 741 and the second front end detection sensor 742.

The direction of the inclination T1 is, for example, an inclination direction D1 or an inclination direction D2. For example, when the second front end detection sensor 742 detects the front end P2f earlier than the first front end detection sensor 741, the calculator 79 calculates the inclination direction D1. The inclination direction D1 indicates, for example, a state where the front end P2f is inclined in the counterclockwise direction with respect to the CD direction. For example, when the first front end detection sensor 741 detects the front end P2f earlier than the second front end detection sensor 742, the calculator 79 calculates the inclination direction D2. The inclination direction D2 indicates, for example, a state where the front end P2f is inclined in the clockwise direction with respect to the CD direction.

The calculator 79 calculates the degree of inclination T1 using, for example, the conveyance speed V (mm/s) of the colorimetric patch printed material P2, the time difference ΔT (ms), and the distance L (mm) between the first front end detection sensor 741 and the second front end detection sensor 742. The time difference ΔT is a difference between a detection time of the front end P2f by the first front end detection sensor 741 and a detection time of the front end P2f by the second front end detection sensor 742.

The calculator 79 first calculates a deviation amount H (mm) of the front end P2f in the FD direction by using the following Expression (1).

$$\begin{matrix}[ Mathematical Expression 1 ] & \\ H = Δ T \times V / 1000 & ( 1 )\end{matrix}$$

Next, the calculator 79 calculates a gradient G1 (%) of the front end P2f using the following Expression (2) or an angle A1 (°) of the front end P2f using Expression (3). For example, the gradient G1 and the angle A1 represent the degree of the inclination T1.

$$\begin{matrix}[ Mathematical Expression 2 ] & \\ G 1 ( \% ) = H / L \times 100 & ( 2 )\end{matrix}$$

$$A 1 ( ° ) = {tan}^{- 1} ( Δ x / Δ y ) \times 180 / π \qquad ( 3 )$$

Information regarding the inclination T1 calculated by the calculator 79 is transmitted to the controller 8.

The controller 8 controls the operation of each functional configuration of the image forming apparatus 1 in accordance with print image data, print settings, and the like. The controller 8 includes, for example, a computer. The controller 8 includes, for example, a CPU, a RAM, and a ROM. The CPU is an abbreviation for “central processing unit”. The RAM is an abbreviation for “random access memory”. The ROM is an abbreviation for “read only memory”.

The CPU executes various control programs to drive and control the image forming apparatus 1 and performs various arithmetic processing. The RAM provides a working memory space for the CPU and temporarily stores data. The RAM may include a nonvolatile memory. The ROM stores various control programs to be executed by the CPU, setting data, and the like. Instead of the ROM, a rewritable nonvolatile memory such as a flash memory may be used.

The controller 8 includes, for example, an overall controller 81, a print controller 82, and a conveyance controller 83. The overall controller 81 performs overall control of the image forming apparatus 1. The print controller 82 controls the printing operation and performs image processing. The overall controller 81 may be an external device including, for example, a personal computer of a client. The overall controller 81 generates print data on the basis of print jobs such as a normal job and a color measurement job. Specifically, the overall controller 81 performs RIP processing, color correction, and conversion into a bitmap format on the image data.

The generated print data is transmitted to, for example, the print controller 82. Note that the print data does not necessarily have to be data generated by the overall controller, and may be data saved in advance. The overall controller 81 controls each component to execute a print job. The overall controller 81 controls the conveyor 3 and the like to convey the normal printed material P1 to the sheet ejector 6 and convey the colorimetric patch printed material P2 to the color measurement device 7.

The print controller 82 controls operations of the conveyor 3, the image former 4, the image scanner 5, and the like, for example, under the control of the overall controller 81. Thus, the normal printed material P1 and the colorimetric patch printed material P2 are formed. Specifically, the print controller 82 performs determination of an ink discharge amount, image processing, colorimetric data processing, head unit driving control, ultraviolet irradiation control, conveyance control, determination of an ink discharge method, determination of an ink amount limit value, acquisition of nozzle deficiency information, acquisition of sheet type information, and the like.

The print controller 82 acquires, for example, colorimetric data about each of the multiple colorimetric patches 201 subjected to color measurement by the color measurement device 7. The print controller 82 adjusts the image color of the normal printed material P1, for example, on the basis of the colorimetric data. Specifically, the print controller 82 controls color calibration, ICC profile creation, and the like. The ICC is an abbreviation for “international color consortium”.

The conveyance controller 83 controls conveyance of the colorimetric patch printed material P2 in the color measurement device 7. Specifically, the conveyance controller 83 acquires the information regarding the inclination T1 from the calculator 79 of the color measurement device 7, and controls the conveyance of the colorimetric patch printed material P2 on the basis of the inclination T1.

The operation section 9 is used when a user inputs various settings for printing, information for creating an ICC profile, and the like.

### [Color Measurement Control]

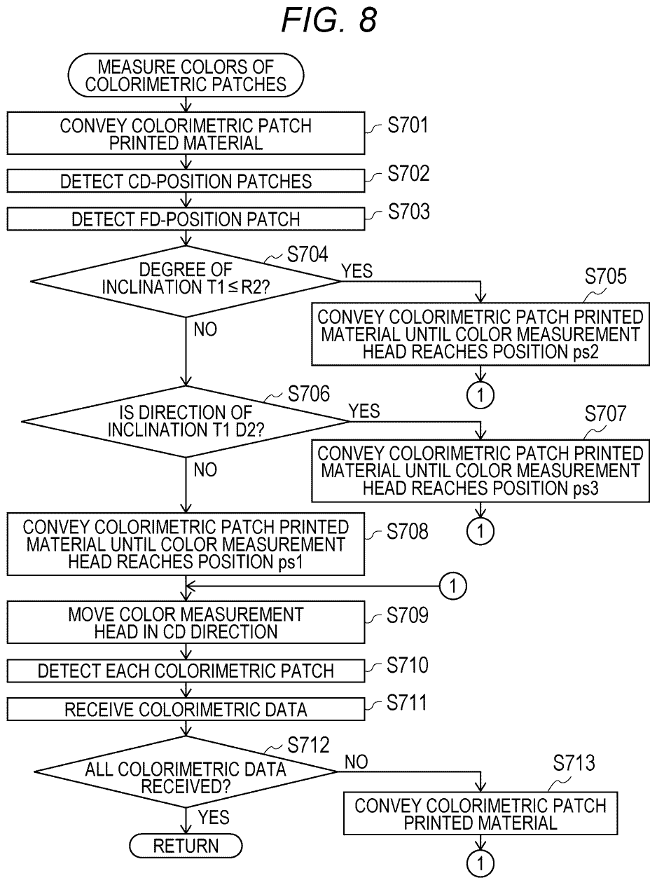

FIG. 7 is a flowchart illustrating an example of the color measurement control for the colorimetric patches 201 executed by the controller 8. The processing which is performed by the controller 8 and which is illustrated in the flowchart of FIG. 7 is stored, for example, as a program in a storage of the image forming apparatus 1 and is executed by the CPU controlling the various sections.

### (Step S101)

First, the controller 8 causes the image former 4 or the like to form the colorimetric patch printed material P2. Specifically, the recording medium M is conveyed to the image former 4, and the colorimetric patches 201 and the position patches 202 are printed on the recording medium M. Thus, the colorimetric patch printed material P2 is formed.

### (Step S102)

Next, the controller 8 controls the conveyor 3 to convey the colorimetric patches 201 formed in step S101 to the color measurement device 7.

### (Step S103)

Next, the controller 8 causes the front end detection sensor 74 to detect the front end P2f of the colorimetric patch printed material P2.

### (Step S104)

Next, the controller 8 causes the calculator 79 to calculate the inclination T1 of the colorimetric patch printed material P2 on the basis of the information detected in step S103. The inclination T1 includes, for example, information regarding the inclination directions D1 and D2 and information regarding at least one of the gradient G1 and the angle A1 of the front end P2f.

### (Step S105)

Next, the controller 8 determines whether or not the degree of the inclination T1 of the colorimetric patch printed material P2 calculated in step S104 is greater than an inclination degree R1. The inclination degree R1 is, for example, an inclination that is too great to accurately perform the color measurement of the colorimetric patches 201 even by controlling the conveyance of the colorimetric patch printed material P2.

### (Step S106)

When the degree of the inclination T1 is equal to or less than the inclination degree R1 (NO in step S105), the controller 8 determines whether or not a predetermined time has elapsed after the printing of the colorimetric patches 201. The predetermined time is a time until the color of the photocurable ink, such as a UV curable ink, used to form the colorimetric patches 201 is stabilized. If the predetermined time has not elapsed (NO in step S106), the controller 8 repeats the process of step S106 in a standby state in which the front end P2f of the colorimetric patch printed material P2 is located at the position 73p in the FD direction.

### (Step S107)

When the predetermined time has elapsed (YES in step S106), the controller 8 allows the color measurement head 71 to measure the colors of the colorimetric patches 201, and ends the processing. Details of the color measurement processing for the colorimetric patches 201 will be described later.

### (Step S108)

When the degree of the inclination T1 is greater than the inclination degree R1 (YES in step S105), the controller 8 discharges the colorimetric patch printed material P2 to the outside of the color measurement device 7 without causing the color measurement head 71 to measure the colors of the colorimetric patches 201, and returns to the process of step S101. Alternatively, the controller 8 may end the processing after executing the process of step S108.

When the degree of the inclination T1 is greater than the inclination degree R1 (YES in step S105), the controller 8 may issue a warning to the user using a display, a speaker, or the like. In this case, for example, the conveyance of the colorimetric patch printed material P2 may be stopped in a standby state in which the front end P2f of the colorimetric patch printed material P2 is located at the position 73p in the FD direction. For example, when the user inputs the completion of the correction of the inclination of the colorimetric patch printed material P2 to the operation section 9, the controller 8 may proceed to the process of step S106.

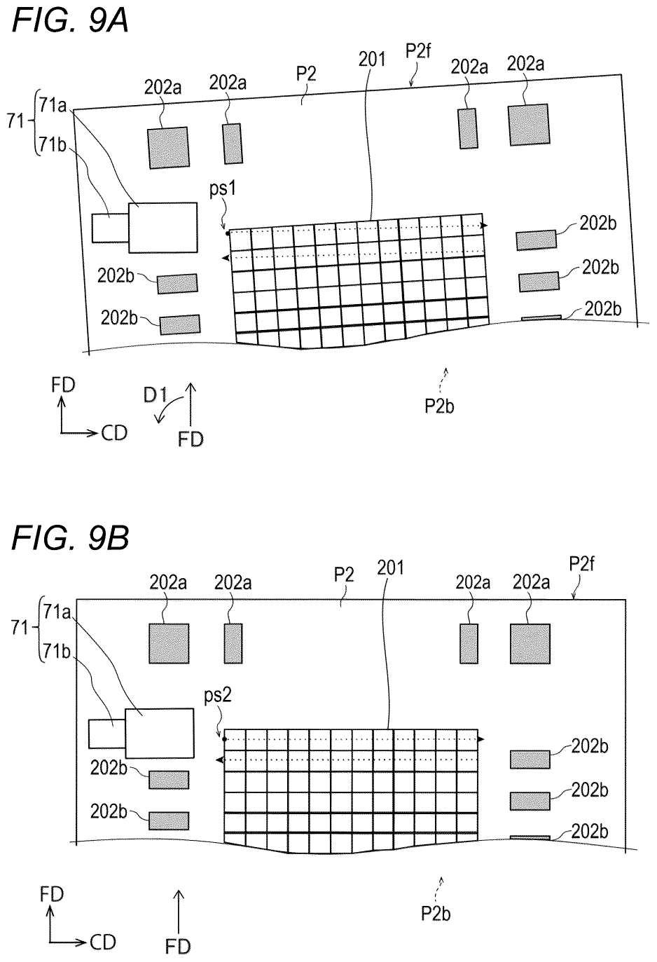

FIG. 8 is a subroutine flowchart illustrating an example of the process of step S107.

### (Step S701)

First, the controller 8 causes the conveyor 3 to convey the colorimetric patch printed material P2. Specifically, the colorimetric patch printed material P2 is conveyed from the standby position to a position where the CD-position patches 202a can be detected by the position sensor 71b. The CD-position patches 202a are arranged, for example, at positions in the FD direction of the position sensor 71b. The controller 8 causes the conveyor 3 to convey the colorimetric patch printed material P2, for example, on the basis of the distance from the front end P2f of the colorimetric patch printed material P2 to the CD-position patches 202a stored in advance. The controller 8 may control the conveyance of the colorimetric patch printed material P2 on the basis of detection of the CD-position patches 202a by the position sensor 71b.

### (Step S702)

Next, the controller 8 causes the position sensor 71b to detect the multiple CD-position patches 202a. Specifically, first, the controller 8 moves the color measurement head 71 to the left home sensor 76, and then causes the color measurement head 71 to perform white calibration by using the white calibration plate 78. Thereafter, the controller 8 moves the color measurement head 71 in the CD direction to detect the CD-position patches 202a in order from the left end P21 side. The controller 8 can specify the positions of the colorimetric patches 201 in the first and twelfth rows in the CD direction by, for example, acquiring information from the position sensor 71b.

### (Step S703)

Next, the controller 8 causes the position sensor 71b to detect the FD-position patches 202b aligned with the colorimetric patches 201 in the first row. Specifically, the controller 8 first moves the position sensor 71b in the CD direction to a position at which the CD-position patch 202a arranged at a position closest to the left end P21 among the multiple CD-position patches 202a is detected. Next, the controller 8 causes the conveyor 3 to convey the colorimetric patch printed material P2 until the position sensor 71b detects the FD-position patches 202b. At this time, the controller 8 stops the conveyance of the colorimetric patch printed material P2 such that the position of the color measurement head 71 reaches a position ps1 described later or a position on the front end P2f side with respect to the position ps1. Next the controller 8 moves the color measurement head 71 to the left home sensor 76, and then causes the color measurement head 71 to perform white calibration by using the white calibration plate 78. Thereafter, the controller 8 causes the position sensor 71b to detect the FD-position patches 202b.

### (Steps S704 to S710)

Next, the controller 8 determines, according to the inclination T1 of the colorimetric patch printed material P2 calculated in step S104, positions ps1, ps2, and ps3 of the colorimetric patches 201 in the FD direction with respect to the color measurement sensor 71a. In other words, the colorimetric patch printed material P2 is conveyed until the color measurement head 71 reaches any one of the positions ps1, ps2, and ps3. Thereafter, the controller 8 moves the color measurement head 71 in the CD direction and causes the color measurement sensor 71a to measure the colors of the colorimetric patches 201.

For example, when the degree of the inclination T1 is greater than an inclination degree R2 and the direction of the inclination T1 is the inclination direction D1 (NO in step S704 and NO in step S705), the controller 8 conveys the colorimetric patch printed material P2 until the color measurement head 71 reaches the position ps1. The inclination degree R2 is smaller than the inclination degree R1 (R2<R1).

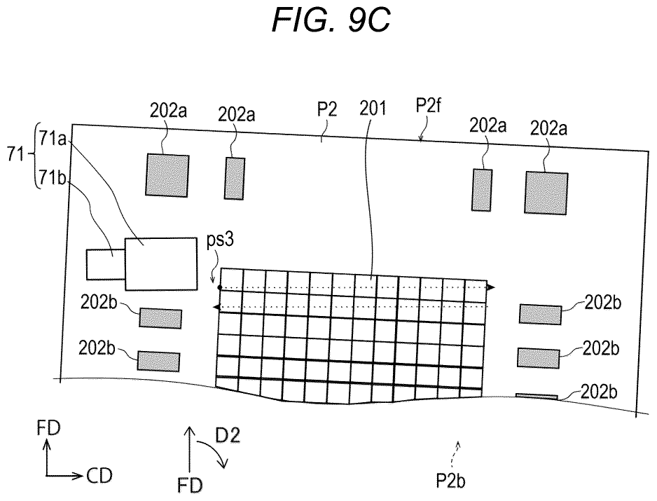

FIG. 9A illustrates the position ps1. The position ps1 is a position closer to the front end P2f with respect to the center in the FD direction at the left end of the colorimetric patch 201 in the odd-numbered row and the first column. The controller 8 moves the color measurement head 71 that has reached the position ps1 in the CD direction. At this time, the color measurement sensor 71a moves in the CD direction from the position ps1, so that the color measurement can be sequentially performed from the colorimetric patch 201 in the first column to the colorimetric patch 201 in the twelfth column without deviating from the colorimetric patches 201 in the first row. Thereafter, the controller 8 conveys the colorimetric patch printed material P2 by one row of the colorimetric patches 201, and causes the color measurement sensor 71a to perform color measurement on the colorimetric patches 201 in the second row. At this time, the color measurement sensor 71a moves in the CD direction from a position closer to the back end P2b with respect to the center in the FD direction at the right end of the colorimetric patch 201 in the second row and the twelfth column. In this way, when the color measurement head 71 reaches the position ps1, the color measurement is started from a position closer to the front end P2f with respect to the center in the FD direction in the colorimetric patches 201 in the odd-numbered rows, and the color measurement is started from a position closer to the back end P2b with respect to the center in the FD direction in the colorimetric patches 201 in the even-numbered rows.

For example, when the degree of the inclination T1 is equal to or less than the inclination degree R2 (YES in step S704), the controller 8 conveys the colorimetric patch printed material P2 until the color measurement head 71 reaches the position ps2.

FIG. 9B illustrates the position ps2. The position ps2 is the center position in the FD direction at the left end of the colorimetric patch 201 in the odd-numbered row and the first column. The controller 8 moves the color measurement head 71 that has reached the position ps2 in the CD direction. At this time, the inclination T1 of the colorimetric patch printed material P2 is small, and the color measurement sensor 71a can sequentially perform the color measurement from the colorimetric patch 201 in the first column to the colorimetric patch 201 in the twelfth column without deviating from the colorimetric patches 201 in the first row. Thereafter, the controller 8 conveys the colorimetric patch printed material P2 by one row of the colorimetric patches 201, and causes the color measurement sensor 71a to perform color measurement on the colorimetric patches 201 in the second row. At this time, the color measurement sensor 71a moves in the CD direction from the center position in the FD direction at the right end of the colorimetric patch 201 in the second row and the twelfth column. In this manner, when the color measurement head 71 reaches the position ps2, the color measurement is started from the center position in the FD direction in both of the colorimetric patches 201 in the odd-numbered rows and the even-numbered rows.

For example, when the degree of the inclination T1 is greater than the inclination degree R2 and the direction of the inclination T1 is the inclination direction D2 (NO in step S704 and YES in step S705), the controller 8 conveys the colorimetric patch printed material P2 until the color measurement head 71 reaches the position ps3.

FIG. 9C illustrates the position ps3. The position ps3 is a position closer to the back end P2b with respect to the center in the FD direction at the left end of the colorimetric patch 201 in the odd-numbered row and the first column. The controller 8 moves the color measurement head 71 that has reached the position ps3 in the CD direction. At this time, the color measurement sensor 71a moves in the CD direction from the position ps3, so that the color measurement can be sequentially performed from the colorimetric patch 201 in the first column to the colorimetric patch 201 in the twelfth column without deviating from the colorimetric patches 201 in the first row. Thereafter, the controller 8 conveys the colorimetric patch printed material P2 by one row of the colorimetric patches 201, and causes the color measurement sensor 71a to perform color measurement on the colorimetric patches 201 in the second row. At this time, the color measurement sensor 71a moves in the CD direction from a position closer to the front end P2f with respect to the center in the FD direction at the right end of the colorimetric patch 201 in the second row and the twelfth column. In this way, when the color measurement head 71 reaches the position ps3, the color measurement is started from a position closer to the back end P2b with respect to the center in the FD direction in the colorimetric patches 201 in the odd-numbered rows, and the color measurement is started from a position closer to the front end P2f with respect to the center in the FD direction in the colorimetric patches 201 in the even-numbered rows.

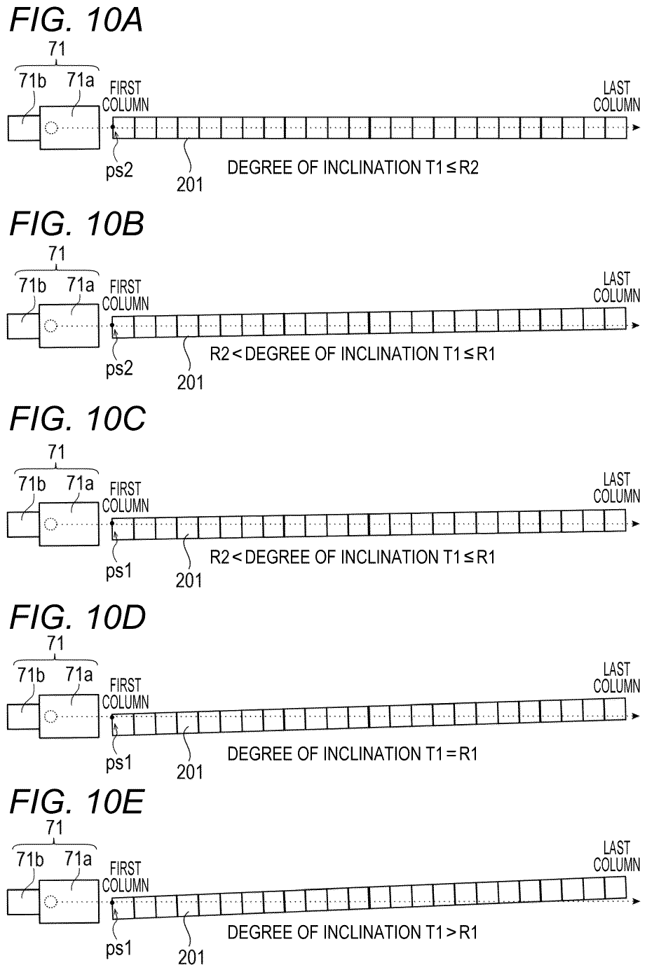

FIGS. 10A to 10E illustrate an example of a relationship between the inclination degrees R1 and R2 and the positions ps1 and ps2. When the degree of the inclination T1 of the colorimetric patch printed material P2 is equal to or less than the inclination degree R2 (FIG. 10A), the color measurement sensor 71a starts the color measurement of the colorimetric patches 201 from the position ps2. At this time, the color measurement sensor 71a can sequentially perform the color measurement up to the colorimetric patch 201 in the last column without deviating from the colorimetric patches 201 in the first row.

FIGS. 10B and 10C illustrate a state in which the degree of the inclination T1 of the colorimetric patch printed material P2 is greater than the inclination degree R2 and equal to or less than the inclination degree R1 (R2<T1≤R1). At this time, when the color measurement sensor 71a starts the color measurement of the colorimetric patches 201 from the position ps2 (FIG. 10B), the colorimetric patches 201 located outside the colorimetric patches 201 in the first row may be subjected to the color measurement in the vicinity of the colorimetric patch 201 in the last column. When the color measurement sensor 71a starts the color measurement of the colorimetric patches 201 from the position ps1 (FIG. 10C), the color measurement sensor 71a can sequentially perform the color measurement up to the colorimetric patch 201 in the last column without deviating from the colorimetric patches 201 in the first row.

FIG. 10D illustrates a state in which the degree of the inclination T1 of the colorimetric patch printed material P2 is equal to the inclination degree R1 (T1=R1). At this time, when the color measurement sensor 71a starts the color measurement of the colorimetric patches 201 from the position ps1, the color measurement sensor 71a can sequentially perform the color measurement up to the colorimetric patch 201 in the last column without deviating from the colorimetric patches 201 in the first row.

FIG. 10E illustrates a state in which the degree of the inclination T1 of the colorimetric patch printed material P2 is greater than the inclination degree R1 (T1>R1). At this time, when the color measurement sensor 71a starts the color measurement of the colorimetric patches 201 from the position ps1, the colorimetric patches 201 located outside the colorimetric patches 201 in the first row are subjected to the color measurement in the vicinity of the colorimetric patch 201 in the last column.

### (Step S711)

The controller 8 receives colorimetric data from the color measurement sensor 71a after, for example, causing the color measurement sensor 71a to measure the colors of the colorimetric patches 201 in the first row. The controller 8 may receive the colorimetric data from the color measurement sensor 71a per color measurement of one colorimetric patch 201, or may receive the colorimetric data from the color measurement sensor 71a after the color measurement of all the colorimetric patches 201.

### (Step S712)

Subsequently, the controller 8 determines whether or not the colorimetric data of all the colorimetric patches 201 have been received. When determining that the colorimetric data of all the colorimetric patches 201 have been received (YES in step S712), the controller 8 ends the processing.

### (Step S713)

When determining that the colorimetric data of all the colorimetric patches 201 have not been received (NO in step S712), the controller 8 causes the conveyor 3 to convey the colorimetric patch printed material P2, and returns to the process of step S709.

### [Operation and Effects of Color Measurement Device and Image Forming Apparatus]

The image forming apparatus 1 according to the present embodiment includes the front end detection sensor 74 and the controller 8. Thus, the conveyance of the colorimetric patch printed material P2 is controlled on the basis of the detected inclination T1 of the colorimetric patch printed material P2. Specifically, when the degree of the inclination T1 of the colorimetric patch printed material P2 is equal to or less than the inclination degree R1, the color measurement of the colorimetric patches 201 is executed. On the other hand, when the degree of the inclination T1 of the colorimetric patch printed material P2 is greater than the inclination degree R1, the color measurement of the colorimetric patches 201 is not executed, and the colorimetric patch printed material P2 is discharged to the outside of the color measurement device 7. Therefore, the color measurement of the colorimetric patches 201 can be adjusted in accordance with the inclination T1 of the colorimetric patch printed material P2. In the image forming apparatus 1 described above, the color measurement is not executed when the degree of the inclination T1 is great, whereby it is possible to efficiently calibrate the color characteristics and the like by eliminating a wasteful color measurement time and the like.

Further, the front end detection sensor 74 is disposed upstream of the color measurement head 71 in the FD direction. Therefore, the inclination T1 of the colorimetric patch printed material P2 can be detected before the color measurement head 71 detects the colorimetric patches 201 or the position patches 202. Thus, the time required for calibration of color characteristics and the like can be shortened, and calibration can be performed more efficiently. This will be described below.

For example, the position patch 202 or the like may be used to detect the inclination of the colorimetric patch printed material P2. In this case, if the colorimetric patches 201 and the position patches 202 are printed with photocurable ink, color change of the colorimetric patches 201 and the position patches 202 may occur due to reaction of a photopolymerization initiator. Therefore, after the image formation in the image former 4, a standby time is required until the colors of the colorimetric patches 201 and the position patches 202 are stabilized. After the standby time has elapsed, the position sensor 71b detects the position patch 202, and the inclination of the colorimetric patch printed material P2 is detected. In a case where the detected inclination of the colorimetric patch printed material P2 is great and the color measurement of the colorimetric patches 201 cannot be performed, the processing is performed again from the creation of the colorimetric patch printed material P2. Therefore, the time required for the calibration may be greatly increased.

On the other hand, in the image forming apparatus 1, the front end detection sensor 74 detects the inclination of the front end P2f of the colorimetric patch printed material P2, thereby detecting the inclination T1. Therefore, the inclination T1 can be detected without waiting for the stabilization of the colors of the colorimetric patches 201 and the position patches 202. Thus, the color characteristics and the like of the image forming apparatus 1 can be calibrated more efficiently.

When the degree of the inclination T1 is equal to or smaller than the inclination degree R1, the conveyance of the colorimetric patch printed material P2 is controlled according to the direction and the degree of the inclination T1. Specifically, the starting positions of color measurement for the colorimetric patches 201 in the odd-numbered rows and the first column are determined from the positions ps1, ps2, and ps3. Thus, the colors of all the colorimetric patches 201 are sequentially measured by the color measurement sensor 71a, which makes it possible to obtain more accurate colorimetric data.

Modification examples of the above-described embodiment will be described below. The same reference numerals are given to the same components as those of the above-described embodiment, and the description thereof will be omitted.

### First Modification Example

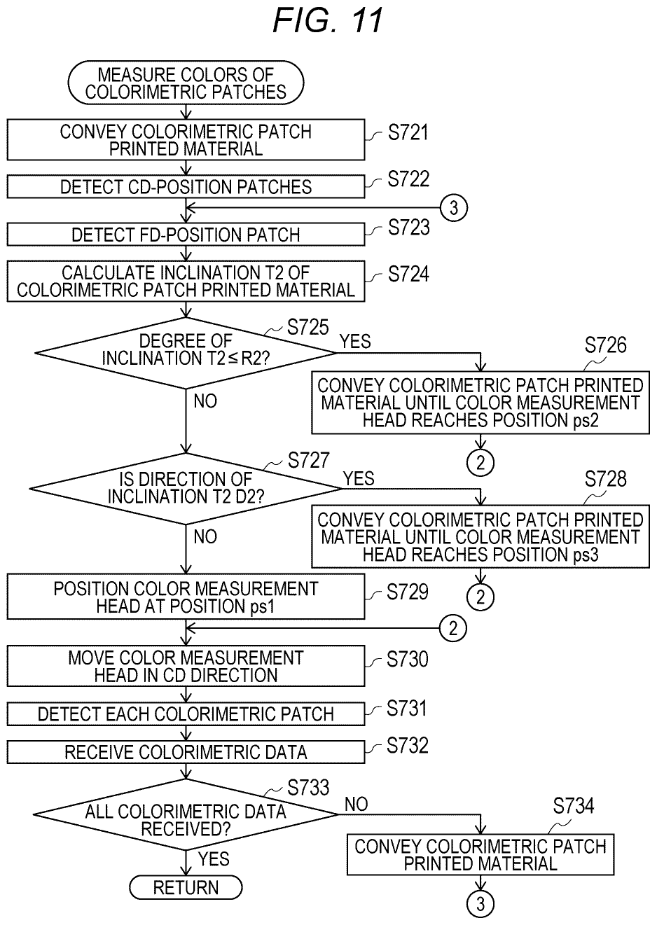

FIG. 11 illustrates an example of a procedure of color measurement for the colorimetric patches 201 executed by an image forming apparatus 1 according to the first modification example. FIG. 11 corresponds to the subroutine flowchart of the process of step S107 illustrated in FIG. 7. In the image forming apparatus 1, a controller 8 detects an inclination T2 in addition to the inclination T1 of the colorimetric patch printed material P2. The inclination T2 is an inclination of the colorimetric patch printed material P2 on the downstream side of the inclination T1 in the FD direction. For example, when a color measurement sensor 71a measures the colors of the multiple colorimetric patches 201, the controller 8 controls the conveyance of the colorimetric patch printed material P2 on the basis of the inclination T2. Except for this point, the image forming apparatus 1 according to the first modification example has the same configuration as that of the image forming apparatus 1 described in the above embodiment, and achieves the same operation and effect.

### (Steps S721 to S723)

First, the controller 8 executes processes of steps S721 to S723 in the same manner as in steps S701 to S703 described above.

### (Step S724)

Next, the controller 8 causes a calculator 79 to calculate the inclination T2 of the colorimetric patch printed material P2. The calculator 79 calculates the inclination T2 of the colorimetric patch printed material P2 on the basis of, for example, the CD-position patches 202a and the FD-position patches 202b detected by the position sensor 71b. The calculator 79 calculates, for example, the direction and the degree of the inclination T2 of the colorimetric patch printed material P2. The inclination T2 includes, for example, a direction and a degree of inclination of the position patch 202 with respect to the CD direction.

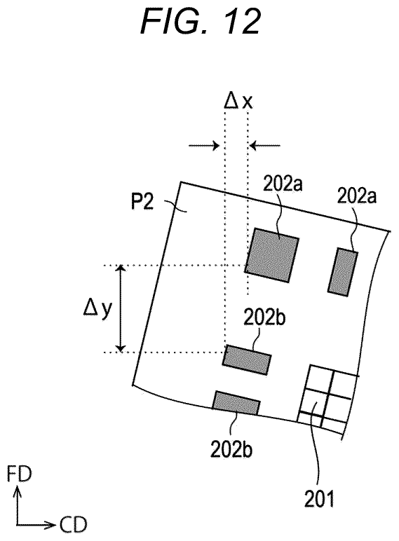

FIG. 12 illustrates an example of a method for calculating the inclination T2. The calculator 79 calculates the degree of the inclination T2 on the basis of, for example, Δx and Δy. The parameter Δx is a distance in the CD direction between the CD-position patch 202a closest to the left end P21 and the FD-position patch 202b aligned with the colorimetric patches 201 in the first row. The parameter Δy is a distance in the FD direction between the CD-position patch 202a closest to the left end P21 and the FD-position patch 202b aligned with the colorimetric patches 201 in the first row.

For example, Δx is the difference between the movement distance of the color measurement head 71 from the left home sensor 76 until the color measurement head 71 detects the CD-position patch 202a closest to the left end P21 and the movement distance of the color measurement head 71 from the left home sensor 76 until the color measurement head 71 detects the FD-position patch 202b aligned with the colorimetric patches 201 in the first row. The calculator 79 may calculate Δx using a movement time instead of the movement distance.

For example, Δy is the conveyance distance of the colorimetric patch printed material P2 from the detection of the CD-position patch 202a to the detection of the FD-position patch 202b aligned with the colorimetric patches 201 in the first row. The calculator 79 may calculate Δy using a conveyance time instead of the conveyance distance.

The calculator 79 calculates a gradient G2 (%) between the CD-position patch 202a and the FD-position patch 202b using the following Expression (4), or calculates an angle A2 (°) between the CD-position patch 202a and the FD-position patch 202b using Expression (5). For example, the gradient G2 and the angle A2 represent the degree of the inclination T2.

$$\begin{matrix}[ Mathematical Expression 3 ] & \\ G 2 ( \% ) = Δ x / Δ y \times 100 & ( 4 )\end{matrix}$$

$$A 2 ( ° ) = {tan}^{- 1} ( Δ x / Δ y ) \times 180 / π \qquad ( 5 )$$

The calculator 79 further calculates the direction of the inclination T2 of the colorimetric patch printed material P2. For example, when the movement distance of the color measurement head 71 from the left home sensor 76 until the color measurement head 71 detects the FD-position patch 202b aligned with the colorimetric patches 201 in the first row is greater than the movement distance of the color measurement head 71 from the left home sensor 76 until the color measurement head 71 detects the CD-position patch 202a closest to the left end P21, the calculator 79 calculates the inclination direction D1. For example, when the movement distance of the color measurement head 71 from the left home sensor 76 until the color measurement head 71 detects the CD-position patch 202a closest to the left end P21 is greater than the movement distance of the color measurement head 71 from the left home sensor 76 until the color measurement head 71 detects the FD-position patch 202b aligned with the colorimetric patches 201 in the first row, the calculator 79 calculates the inclination direction D2.

### (Steps S725 to S731)

Next, the controller 8 determines, according to the inclination T2 calculated in step S724, positions ps1, ps2, and ps3 of the colorimetric patches 201 in the FD direction with respect to the color measurement sensor 71a. In other words, the colorimetric patch printed material P2 is conveyed until the color measurement head 71 reaches any one of the positions ps1, ps2, and ps3 of the colorimetric patches 201. Thereafter, the controller 8 moves the color measurement head 71 in the CD direction and causes the color measurement sensor 71a to sequentially measure the colors of the colorimetric patches 201.

For example, when the degree of the inclination T2 is greater than the inclination degree R2 and the direction of the inclination T2 is the inclination direction D1 (NO in step S725 and NO in step S727), the controller 8 conveys the colorimetric patch printed material P2 until the color measurement head 71 reaches the position ps1. In step S703, when the conveyance of the colorimetric patch printed material P2 is stopped at the position where the color measurement head 71 reaches the position ps1, the controller 8 may not convey the colorimetric patch printed material P2.

For example, when the degree of the inclination T2 is equal to or less than the inclination degree R2 (YES in step S725), the controller 8 conveys the colorimetric patch printed material P2 until the color measurement head 71 reaches the position ps2.

For example, when the degree of the inclination T2 is greater than the inclination degree R2 and the direction of the inclination T2 is the inclination direction D2 (YES in step S725 and YES in step S727), the controller 8 conveys the colorimetric patch printed material P2 until the color measurement head 71 reaches the position ps3.

### (Step S732)

The controller 8 receives colorimetric data from the color measurement sensor 71a after, for example, causing the color measurement sensor 71a to measure the colors of the colorimetric patches 201 in the first row.

### (Step S733)

Subsequently, the controller 8 determines whether or not the colorimetric data of all the colorimetric patches 201 have been received. When determining that the colorimetric data of all the colorimetric patches 201 have been received (YES in step S733), the controller 8 ends the processing.

### (Step S734)

When determining that the colorimetric data of all the colorimetric patches 201 have not been received (NO in step S733), the controller 8 causes the conveyor 3 to convey the colorimetric patch printed material P2, and returns to the process of step S723. The controller 8 calculates the inclination T2 again using, for example, the FD-position patch 202b aligned with the colorimetric patches 201 in the first row and the FD-position patch 202b aligned with the colorimetric patches 201 in the third row, and then causes the color measurement sensor 71a to measure the colors of the colorimetric patches 201 in the third row.

For example, the controller 8 may control the conveyance of the colorimetric patch printed material P2 on the basis of the inclination T1 when the color measurement sensor 71a measures the colors of some of the colorimetric patches 201 and control the conveyance of the colorimetric patch printed material P2 on the basis of the inclination T2 when the color measurement sensor 71a measures the colors of the other colorimetric patches 201. For example, the controller 8 may cause the color measurement sensor 71a to measure the colors of the colorimetric patches 201 in the first and second rows on the basis of the inclination T1 (steps S704 to S710) and then cause the color measurement sensor 71a to measure the colors of the colorimetric patches 201 in the third and subsequent rows on the basis of the inclination T2 (steps S725 to S731).

Since the image forming apparatus 1 according to the first modification example also includes the front end detection sensor 74 and the controller 8, the conveyance of the colorimetric patch printed material P2 is controlled on the basis of the detected inclination T1 of the colorimetric patch printed material P2. Therefore, the color measurement of the colorimetric patches 201 can be adjusted in accordance with the inclination T1 of the colorimetric patch printed material P2.

Furthermore, in the image forming apparatus 1, after the detection of the inclination T1, the inclination T2 is detected using the position patches 202. Accordingly, it is possible to detect the inclination of the colorimetric patches 201 and the position patches 202 with respect to the recording medium M, that is, the inclination caused by the image formation. Furthermore, it is also possible to detect the inclination of the colorimetric patch printed material P2 caused by repeating the conveyance and the stop of the conveyance of the colorimetric patch printed material P2. As described above, in the image forming apparatus 1, the inclination of the colorimetric patch printed material P2 is detected more finely, and thus, more accurate colorimetric data can be obtained.

### Second Modification Example

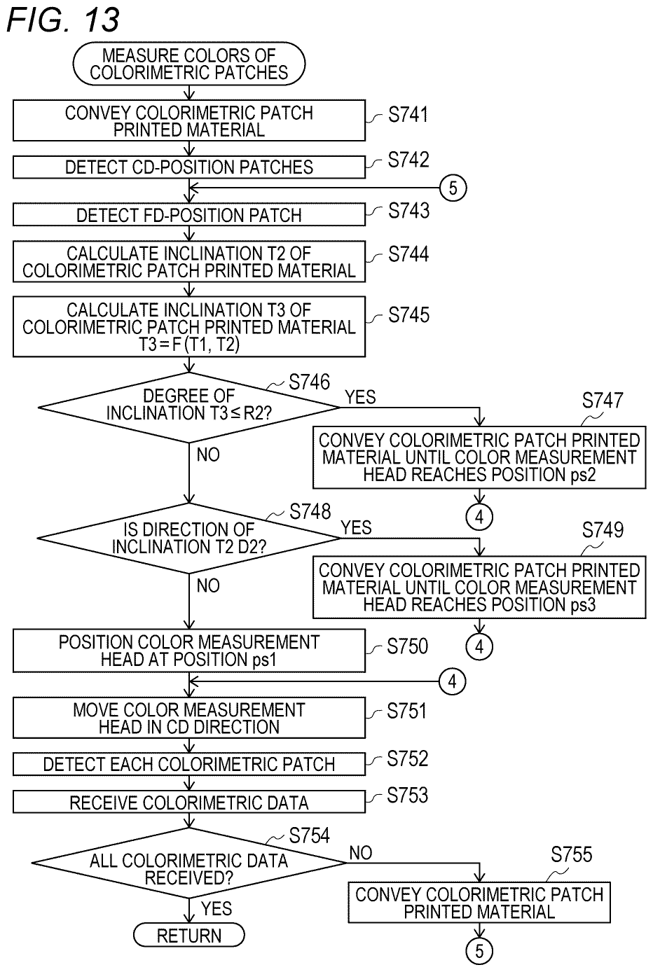

FIG. 13 illustrates an example of a procedure of color measurement for the colorimetric patch 201 executed by an image forming apparatus 1 according to the second modification example. FIG. 13 corresponds to the subroutine flowchart of the process of step S107 illustrated in FIG. 7. In the image forming apparatus 1, a controller 8 detects an inclination T3 in addition to the inclinations T1 and T2 of the colorimetric patch printed material P2. When a color measurement sensor 71a measures the colors of the multiple colorimetric patches 201, the controller 8 controls the conveyance of the colorimetric patch printed material P2 on the basis of the inclination T3. Except for this point, the image forming apparatus 1 according to the second modification example has the same configuration as that of the image forming apparatus 1 described in the first modification example, and achieves the same operation and effect.

### (Steps S741 to S744)

First, the controller 8 executes processes of steps S741 to S744 in the same manner as in steps S721 to S724 described above.

### (Step S745)

Next, the controller 8 causes a calculator 79 to calculate the inclination T3 on the basis of the inclination T1 calculated in step S104 and the inclination T2 calculated in step S724. Specifically, the calculator 79 performs statistical processing on the inclinations T1 and T2. The statistical processing includes, for example, at least one of simple moving average, cumulative moving average, linear weighted moving average, and exponential weighted moving average. In the statistical processing, the inclination T2 may be weighted more than the inclination T1.

The statistical processing may include outlier removal. For example, when the direction of one inclination T2 among a plurality of inclinations T2 is different, the calculator 79 may calculate the inclination T3 by excluding the inclination T2 having a different direction.

### (Steps S746 to S752)

Next, the controller 8 determines, according to the inclination T3 of the colorimetric patch printed material P2 calculated in step S745, positions ps1, ps2, and ps3 of the colorimetric patches 201 in the FD direction with respect to the color measurement sensor 71a. In other words, the colorimetric patch printed material P2 is conveyed until the color measurement head 71 reaches any one of the positions ps1, ps2, and ps3. Thereafter, the controller 8 moves the color measurement head 71 in the CD direction and causes the color measurement sensor 71a to sequentially measure the colors of the colorimetric patches 201.

For example, when the degree of the inclination T3 is greater than the inclination degree R2 and the direction of the inclination T3 is the inclination direction D1 (NO in step S746 and NO in step S748), the controller 8 locates the color measurement head 71 at the position ps1.

For example, when the degree of the inclination T3 is equal to or less than the inclination degree R2 (YES in step S746), the controller 8 conveys the colorimetric patch printed material P2 until the color measurement head 71 reaches the position ps2.

For example, when the degree of the inclination T3 is greater than the inclination degree R2 and the direction of the inclination T3 is the inclination direction D2 (YES in step S746 and YES in step S748), the controller 8 conveys the colorimetric patch printed material P2 until the color measurement head 71 reaches the position ps3.

### (Step S753)

The controller 8 receives colorimetric data from the color measurement sensor 71a after, for example, causing the color measurement sensor 71a to measure the colors of the colorimetric patches 201 in the first row.

### (Step S754)

Subsequently, the controller 8 determines whether or not the colorimetric data of all the colorimetric patches 201 have been received. When determining that the colorimetric data of all the colorimetric patches 201 have been received (YES in step S753), the controller 8 ends the processing.

### (Step S755)

When determining that the colorimetric data of all the colorimetric patches 201 have not been received (NO in step S754), the controller 8 causes the conveyor 3 to convey the colorimetric patch printed material P2, and returns to the process of step S743. The calculator 79 calculates the inclinations T2 and T3 again using, for example, the FD-position patch 202b aligned with the colorimetric patches 201 in the first row and the FD-position patch 202b aligned with the colorimetric patches 201 in the third row.

Since the image forming apparatus 1 according to the second modification example also includes the front end detection sensor 74 and the controller 8, the conveyance of the colorimetric patch printed material P2 is controlled on the basis of the detected inclination T1 of the colorimetric patch printed material P2. Therefore, the color measurement of the colorimetric patches 201 can be adjusted in accordance with the inclination T1 of the colorimetric patch printed material P2.

In the image forming apparatus 1, the inclination T3 based on the inclinations T1 and T2 is calculated. This makes it possible to more accurately detect the inclination of the colorimetric patch printed material P2 at the time of color measurement. Therefore, more accurate colorimetric data can be obtained.

The configurations of the image forming apparatus 1 and the color measurement device 7 described above are merely main configurations for describing the features of the above-described embodiment and the modification examples, and can be variously modified within the scope of the claims without being limited to the above-described configurations. Furthermore, the descriptions above are not intended to exclude any configuration included in a general image forming apparatus and color measurement device.

For example, the color measurement device 7 may include a controller, and the controller may have some of the functions of the controller 8. For example, the controller of the color measurement device 7 may control the conveyance of the colorimetric patch printed material P2 on the basis of the inclinations T1, T2, and T3. For example, the image forming apparatus 1 may be provided with a calculator that calculates the inclination T1 and a calculator that calculates the inclination T2 separately.

Furthermore, although the above embodiment has described an example in which the position patch 202 on the left end P21 side is used to calculate the inclination T2, the position patch 202 on the right end P2r side may be used to calculate the inclination T2. Alternatively, the position patches 202 on the left end P21 side and on the right end P2r side may be used to calculate the inclination T2.

In addition, some of the steps in the flowchart described above may be omitted, and other steps may be added. Further, some of the steps may be executed at the same time, and one step may be divided into a plurality of steps and executed.

Furthermore, means and methods for performing various kinds of processing in the image forming apparatus 1 described above can be implemented by any of a dedicated hardware circuit and a programmed computer. The above program may be provided by a computer-readable storage medium such as a USB memory or a DVD-ROM, or may be provided online via a network such as the Internet. In this case, the program recorded on the computer-readable storage medium is usually transferred to and stored in a storage such as a hard disk. Furthermore, the program may be provided as independent application software, or may be incorporated in software of an apparatus such as the image forming apparatus 1 as one function.

Although embodiments of the present invention have been described and illustrated in detail, the disclosed embodiments are made for purpose of illustration and example only and not limitation. The scope of the present invention should be interpreted by terms of the appended claims.

What is claimed is:

1. A color measurement device comprising:
first detection means that detects an inclination of a recording medium on which a colorimetric patch is formed and which is conveyed in a first direction;
a first hardware processor that controls conveyance of the recording medium based on the inclination of the recording medium detected by the first detection means; and
a color measurement sensor that is able to measure a color of the colorimetric patch on the recording medium that is conveyed, being controlled by the first hardware processor.

2. The color measurement device according to claim 1, wherein the first detection means detects a direction and a degree of the inclination of the recording medium.

3. The color measurement device according to claim 1, wherein the color measurement sensor is movable in a second direction intersecting the first direction.

4. The color measurement device according to claim 3, wherein the first detection means detects the inclination of the recording medium by detecting an inclination of an end portion of the recording medium in the first direction with respect to the second direction.

5. The color measurement device according to claim 4, wherein
the first detection means includes
a first end sensor and a second end sensor that are spaced apart from each other in the second direction and that detect the end portion of the recording medium in the first direction, and
a second hardware processor that calculates the inclination of the end portion of the recording medium in the first direction based on information detected by each of the first end sensor and the second end sensor.

6. The color measurement device according to claim 5, wherein the first end sensor and the second end sensor are disposed upstream of the color measurement sensor in a conveyance direction of the recording medium.

7. The color measurement device according to claim 6, wherein, when the inclination of the recording medium detected by the first detection means is greater than a predetermined inclination, the first hardware processor discharges the recording medium to an outside of the color measurement device without causing the color measurement sensor to measure the color of an image of the colorimetric patch formed on the recording medium.

8. The color measurement device according to claim 7, wherein the first hardware processor determines the position of the colorimetric patch in the first direction with respect to the color measurement sensor according to the inclination of the recording medium detected by the first detection means when the inclination of the recording medium detected by the first detection means is equal to or less than the predetermined inclination.

9. The color measurement device according to claim 5, further comprising second detection means that detects an inclination of the recording medium on a downstream side of the first detection means in a conveyance direction of the recording medium, wherein
the first hardware processor controls the conveyance of the recording medium further based on the inclination of the recording medium detected by the second detection means.

10. The color measurement device according to claim 9, wherein images of a plurality of position patches are further formed on the recording medium so as to be separated from each other in the first direction and aligned in the second direction, and
the second detection means detects the inclination of the recording medium by detecting inclinations of the plurality of position patches with respect to the second direction.

11. The color measurement device according to claim 10, wherein
the second detection means includes
a position sensor that detects the plurality of position patches, and
a third hardware processor that calculates the inclinations of the plurality of position patches based on information detected by the position sensor.

12. The color measurement device according to claim 11, wherein images of a plurality of the colorimetric patches are formed on the recording medium along each of the first direction and the second direction.

13. The color measurement device according to claim 12, wherein, when the color measurement sensor measures colors of the plurality of colorimetric patches, the first hardware processor controls the conveyance of the recording medium based on the inclination of the recording medium detected by the second detection means.

14. The color measurement device according to claim 12, wherein, when the color measurement sensor measures a color of at least one of the plurality of colorimetric patches, the first hardware processor controls the conveyance of the recording medium based on the inclination of the recording medium detected by the first detection means, and
when the color measurement sensor measures a color of another colorimetric patch among the plurality of colorimetric patches, the first hardware processor controls the conveyance of the recording medium based on the inclination of the recording medium detected by the second detection means.

15. The color measurement device according to claim 12, wherein, when the color measurement sensor measures colors of the plurality of colorimetric patches, the first hardware processor controls the conveyance of the recording medium based on the inclinations of the recording medium detected by the first detection means and the second detection means.

16. The color measurement device according to claim 15, wherein the first hardware processor performs statistical processing on the inclinations of the recording medium detected by the first detection means and the second detection means to control the conveyance of the recording medium.

17. The color measurement device according to claim 16, wherein the statistical processing includes at least one of simple moving average, cumulative moving average, linear weighted moving average, and exponential weighted moving average.

18. The color measurement device according to claim 16, wherein in the statistical processing, the inclination of the recording medium detected by the first detection means is weighted more than the inclination of the recording medium detected by the second detection means.

19. The color measurement device according to claim 16, wherein the statistical processing includes outlier removal.

20. An image forming apparatus comprising:
the color measurement device according to claim 1; and
an image former that forms an image of the colorimetric patch on the recording medium.
